(19) United States
(12) Patent Application Publication
(10) Pub. No.: US 2010/0037086 A1
(43) Pub. Date: Feb. 11, 2010

(54) ROBUST CRITICAL SECTION DESIGN IN MULTITHREADED APPLICATIONS

(75) Inventor: Emmanuel Mellery, Hannut (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/440,022

(22) PCT Filed: Sep. 19, 2007
(86) PCT No.: PCT/IB07/53802

§ 371 Date: Mar. 5, 2009

Related U.S. Application Data
(60) Provisional application No. 60/826,791, filed on Sep. 25, 2006.

(51) Int. Cl. G06F 11/07; G06F 11/00

(52) U.S. Cl. 714/2; 714/1; 714/E11.023; 714/E11.144

(57) ABSTRACT

A multithreaded computer application provides more robust mutually exclusive accesses as instantiations (threads) of a single program, such that deadlock situations are avoided. The application method uses the system primitives to implement system services that provide a ‘gate’ functionality (S1, S4, S6, S21, S24, S30) to the functional code for which exclusive access is to be granted. Critical sections still exist, but they are only used for the management of state variables and decisional branching of this ‘gate’ mechanism. Also, time limit provisions (S 15) are implemented to avoid blocking of the not granted threads. The method includes executing the ‘exclusive functional code section’ outside the critical sections, which avoids a cascading of blocking effects due to a never ending or non-terminating critical section as in the prior art design model.

This invention relates generally to the field of autonomous multithreaded computer system applications having mutually exclusive accesses to one or more resources from multiple clients, and particularly to a multithreaded computer application requiring more robust mutually exclusive accesses as instantiations (threads) of a single program, such that deadlock situations are avoided.

Asynchronous parallel services of multiple functional requests from “clients” in electronic and computer devices are frequently software implemented using a multithreaded programming model on system platforms that support this model. A typical example is the signaling handler of a multi-port communication system where a finite-state-machine (FSM) implements all the states and transitions required to handle all possible input signals. Many virtual instantiations of the same FSM run in parallel to serve the asynchronous communication ports independently. This approach requires the system to be able to timely switch the context based on periodic system preemption or application decision. In this environment, only a few thread-associated variables are used to personify the state for each channel to be served.

Compared to multi-process configurations, multithreaded applications are far more efficient in terms of context switching performance and system resources allocation because the active threads share the same process space and local resources. A good example is managing a fast matrix-structured switch area for communication equipment. Each switch is operated from a software state machine running on the host system and communicating through a common interface used to control the relevant switch. For example, a microcontroller running in multithreaded OS environment is suitable to control the switches through I/O operations.

Classical implementation of this system is done through the use of simple “synchronization” primitives that delimit a critical section of software code, that is, the code in which the shared access is performed. Such primitives exist in one form or another in multithreaded OS or virtual machines used to support JAVA languages. This simple design method works well when the developer follows the normal rules for shared resources management in critical sections that are not supposed to hang for external reasons. Unfortunately, synchronous I/Os are often performed in critical sections dedicated for the control of shared equipment. If this I/O does not terminate for any reason, the entire system can reach a complete deadlock situation as every thread will eventually attempt to enter the critical section on its turn and each will fall into an indefinite suspend state.

The problem of multithreading is a higher vulnerability to data corruption and frequent deadlocks resulting from the shared address space. Such failures are difficult to detect and to repair as their conditions and time of occurrence are most often unpredictable.

Multithreaded applications that run on preemptive systems require additional means to grant exclusive access to the shared resources. As mentioned above, this is usually achieved through calls to system primitives that delimit a ‘critical section’ of software code aimed to such manipulation, the ‘critical section’ of software code containing ‘protected code’ or instructions for accessing one or more shared resource. The system grants only one thread access to enter and execute the critical section code at a time; any concurrent thread attempting to enter this critical section is suspended, that is, placed in a suspended state, until the granted thread exits the critical section.

Protected or exclusive access to shared resources can be guaranteed by a number of methods, including through the use of critical sections of software code. U.S. Pat. No. 5,941,975, for example, discloses a latch data structure for effectively controlling the users′ simultaneous accesses to a critical section in a system supporting a multi-user environment. The latch data structure is used for providing a schedule for user requests. Another method for guaranteeing protected access to shared resources can be found in U.S. Pat. 6,722,153 which discloses a lock implemented by assigning the lock to a thread. The state of the lock can be changed from non-sharing to atomic operations that support object sharing.

A major problem with critical section software code results from its simplicity of use and implementation. For example, in some systems, the suspended state of any concurrent thread is not time limited. Further, assuming a correct software implementation, one might reasonably expect that the critical section code execution is in all cases of finite duration. Unfortunately, critical section code can still hang-up, or fail to terminate, due to a blocking external condition like a memory mapped I/O operation that never returns. This non-terminating condition would cause the granted thread to indefinitely suspend inside the critical section, and further cause all concurrent threads to be trapped in their suspended states when they attempt to enter the same critical section. The prior art does not address non-terminating critical sections, that is, critical sections that fail to terminate or deadlock because of I/O failures.

It is an object of the present invention to provide a multithreaded computer system and method where deadlock situations are avoided.

It is a further object of the present invention to provide a way to minimize the effect of synchronized I/O failures in autonomous multithreaded systems.

Further to these objects, a solution is provided such that critical sections of software code are only used to access state variables which dictate the access conditions to the protected code through a few system primitives. By an appropriate design of these new primitives, the protected code is located outside the critical section code boundaries, thus avoiding a cascading deadlock effect.

It is known in the art to use critical section primitives, e.g. ENTER, EXIT, to encapsulate or delineate functional code such as, for example, code or instructions for accessing shared resources such as I/O devices. The present method, however, uses the primitives to implement system services that provide a ‘gate’ functionality to the functional code for which exclusive access is to be granted. Critical sections still exist, but they are only used for the management of state variables and decisional branching of this ‘gate’ mechanism. Also, time limit provisions are implemented to avoid blocking of the not granted threads. By an appropriate design of the new services, the ‘exclusive functional code section’ is executed outside the critical sections, which avoids a cascading of blocking effects due to a never ending or non-terminating critical section as in the prior art design model.

The objects, features and advantages of the invention are understood within the context of the Description of the Preferred Embodiments, as set forth below.

The Description of the Preferred Embodiments is understood within the context of the accompanying drawings, which form a material part of this disclosure, wherein:

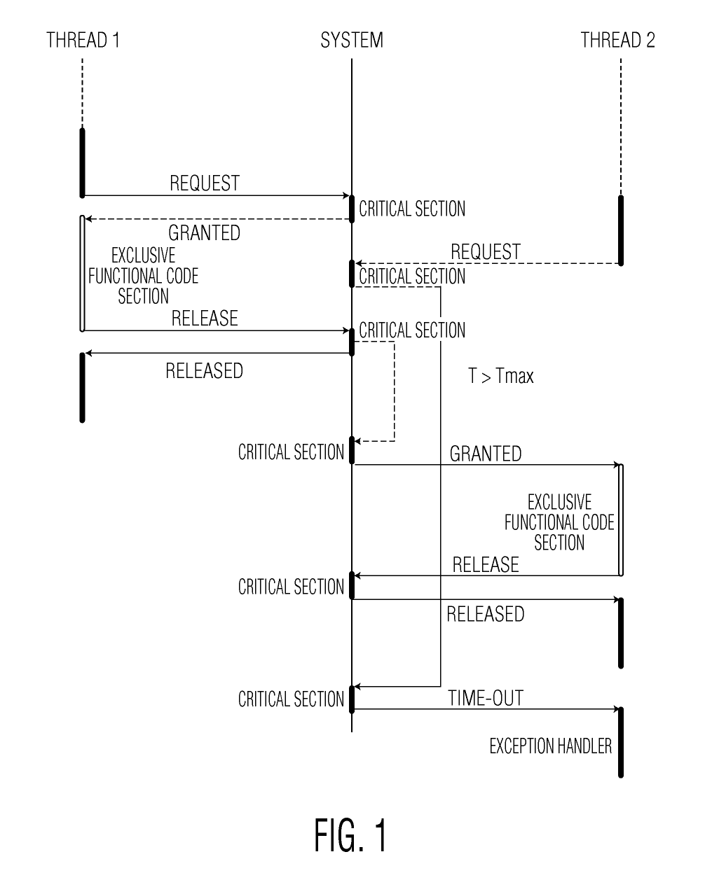

FIG. 1 illustrates a schematic of the invention; and

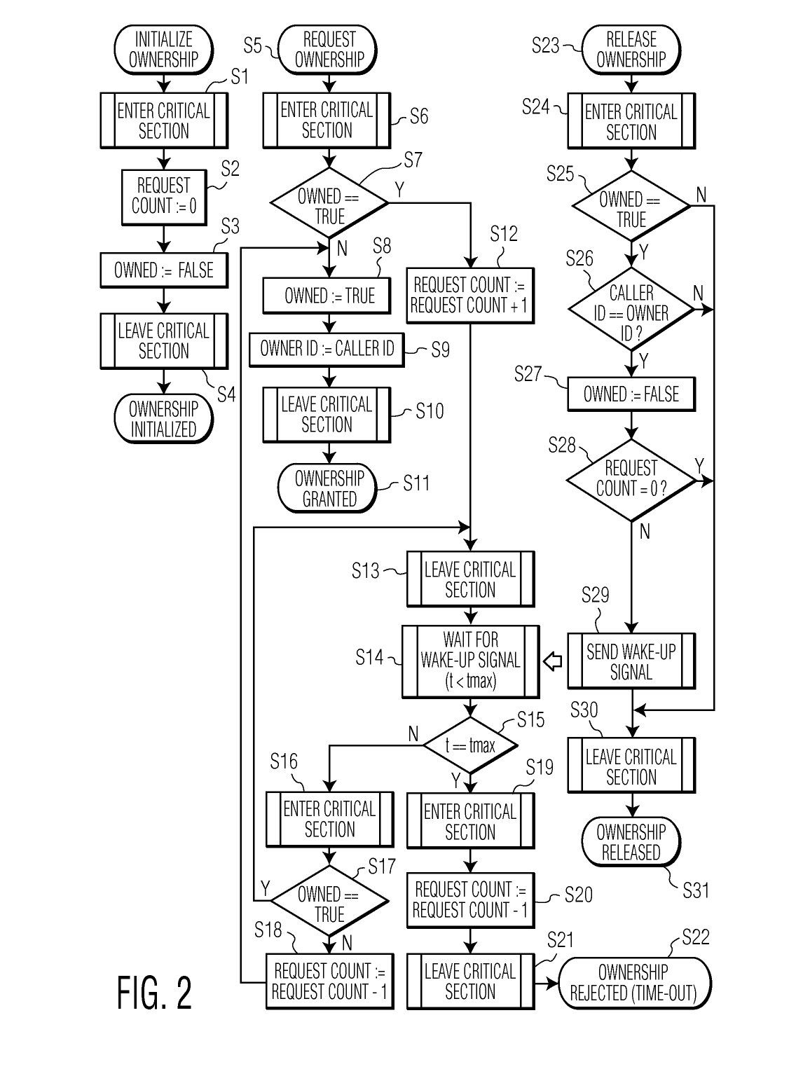

FIG. 2 depicts a flowchart of an embodiment of the present invention.

Aspects of the invention will be described with reference to the following definitions.

‘Critical section’ is any section of code delimited by two system primitives, e.g. ENTER, EXIT, that automatically protect a granted thread entering the section against any concurrent thread access to the same section.

‘Exclusive functional code section’ is the functional code that should be accessed by one single thread at a time.

The invention allows pure software implementation using only existing OS services available in simple multithreading environments found in embedded systems. Standard system primitives, e.g. ‘Enter Critical Section’, ‘Leave Critical Section’, synchronize {}, can be used to test and manipulate the decisional variables, e.g. ‘owned’, ‘owner ID’, ‘Request Count’, needed to control and grant a thread access to the exclusive functional code section. Accordingly, these testing and manipulating operations are all executed in mutual exclusion mode. All the sequences implemented in mutual access condition complete in a finite time as they do not include any I/O or other external dependency condition. Therefore the ‘synchronized’ threads are never blocked. In addition, a strategy to diagnose or recover the operational state can be initiated when the service to request the resource times out.

FIG. 1 is a schematic diagram of an embodiment of the present invention, and FIG. 2 is a flowchart of this embodiment; both are described in detail as follows.

The system is initialized in step S1, wherein the critical section is entered. Step S2 initializes the request count variable to zero (request count=0), and step S3 initializes the owned variable to FALSE. In step S4, the critical section is exited.

When access to the exclusive functional code section is needed by, for example, Thread 1, the procedure is as follows. In step S5, Thread 1 first requests exclusive access to the exclusive functional code section through a call to a ‘request’ primitive. This request service enters a critical section, step S6, and checks the status of the requested exclusive functional code section in step S7. If the status has the value ‘not granted’, the following actions occur. Access is enabled for Thread 1, and the status is changed to ‘granted to Thread 1′ (e.g. owned=TRUE) in step S8 and the owner ID variable is set to the caller id (Thread 1) in step S9. Then the request service exits the critical section, step S10, and returns to Thread 1 with ‘granted’ as result in step S11. Thread 1 then executes the exclusive functional code section.

While access is already granted to Thread 1, Thread 2 requests exclusive access to the exclusive functional code section in step S5. The system service enters the critical section in step S6 and checks the status of the exclusive functional code section in step S7. If the status has the value ‘granted’ and the thread owner identity (owner ID) is not Thread 2, access is not immediately granted to Thread 2. Instead, the request count is increased in step S12, the system service exits the critical section in step S13 and puts Thread 2 (the calling thread) in suspended state in step S14. Thread 2 is then waiting for a ‘release’ signal to be sent by the service at the completion of the exclusive functional code section, or by the system on a time-out condition.

Upon completion of the exclusive functional code section, Thread 1 explicitly calls a ‘release’ primitive in step S23. The release service enters a critical section in step S24 and checks the variables indicating the status of the requested functional code, step S25, and the owner identity in step S26. If the status is ‘granted to Thread 1’, the service is entitled to release the granted access and performs the following steps. In step S27, the status is changed to ‘not granted’, e.g. the variable owned is set to False, and in step S28, the request count is checked for possible suspended threads. If suspended threads are indicated, e.g. request count not zero in step S29, a signal is sent to wake-up the suspended thread(s). Then the service exits the critical section in step S30 and returns to Thread 1 with ‘released’ as result in step S31.

When a suspended thread (Thread 2) receives a release signal on a time out condition, step S15, (e.g. t==tmax), a critical section is entered in step S19, to flush the timed out request, and the following steps are performed. The request count is decreased in step S20, the critical section is exited in step S21, and the suspended thread resumes in step S22.

When a suspended thread (Thread 2) receives a release signal, and, in step S15, it is determined that a time out has not occurred, (e.g. t not equal to tmax), a critical section is entered, step S16. If the exclusive function code is not granted (e.g. step 17: owned is not TRUE), then the request count is decreased in step S18, the status is changed to ‘granted to Thread 2’ (e.g. owned=TRUE) in step S8 and the owner ID variable is set to the caller id (Thread 2) in step S9. Then the request service exits the critical section, step S10, and returns to Thread 2 with ‘granted’ as result in step S11. Thread 2 then executes the exclusive functional code section. However, if the exclusive function code is granted (e.g. step 17: owned is TRUE), then the critical section is exited in step S13 and Thread 2 remains suspended.

Further, a time-out attempt could, e.g., proceed with the sending of a signal to a dedicated monitoring task. As shown in step S22, the signal can indicate the thread ID that abnormally owns the resource so that the monitor can start a diagnostic process and isolate the suspected circuit.

The status variables (grant, counter, . . . ) are local to the exclusive functional code section, i.e. they form together a unique object which has a one-to-one relationship with the exclusive functional code to be protected. If the exclusive functional code section is not trivial to the system, the object must be referenced as an attribute (parameter) of the request/release primitives. In such a case, additional primitives to allocate/initialize the status object need to be implemented.

While it is apparent that the invention herein disclosed is well calculated to fulfill the objects stated above, it will be appreciated that numerous modifications and embodiments may be devised by those skilled in the art and it is intended that the appended claims cover all such modifications and embodiments as fall within the true spirit and scope of the present invention.

1. A method for minimizing the effect of synchronized I/O failures, said method comprising:
initializing critical section primitives for delimiting at least one critical section;
initializing decisional variables (S2, S3) for controlling and granting a thread access to an exclusive function code section;
determining a status of the exclusive function code section (S7) in response to a request for access (S5) to the exclusive function code section by the thread;
executing the exclusive function code section if the status is granted (S11), and, upon completion of execution, releasing the exclusive function code section (S23) and sending a release signal (S29);
suspending the thread if the status is not granted (S22), and upon receipt of the release signal (S14), executing the exclusive function code section and releasing the exclusive function code section upon completion of execution (S31), wherein:
the at least one critical section contains no external dependency condition.

2. The method according to claim 1, wherein said critical section primitives are comprised of ‘Enter Critical Section’, ‘Leave Critical Section’, synchronize {}.

3. The method according to claim 1, wherein said decisional variables (S2, S3) are comprised of ‘owned’, ‘owner ID’, ‘Request Count’.

4. The method according to claim 1, wherein said executing the exclusive function code section if the status is granted further comprises setting one or more decisional variables to the thread (S9).

5. The method according to claim 1, wherein said suspending the thread if the status is not granted further comprises increasing a request count (S12).

6. A method for minimizing the effect of synchronized I/O failures, said method comprising:
initializing critical section primitives for delimiting at least one critical section;
initializing decisional variables (S2, S3) for controlling and granting a thread access to an exclusive function code section;
determining a status of the exclusive function code section (S7) in response to a request for access (S5) to the exclusive function code section by the thread;
executing the exclusive function code section if the status is granted (S11), and, upon completion of execution, releasing the exclusive function code section (S23) and sending a release signal (S29);
suspending the thread if the status is not granted (S22), and upon receipt of a system time-out signal, executing the exclusive function code section and releasing the exclusive function code section upon completion of execution (S31), wherein
the at least one critical section contains no external dependency condition.

7. The method according to claim 6, wherein a critical section is entered (S19) to flush the time out request (S20).

8. The method according to claim 6, wherein a recover operational state is executed in response to the system time-out signal (S22).

9. The method according to claim 6, wherein a signal is sent to a dedicated monitoring task in response to the system time-out signal.

10. The method according to claim 9, wherein the signal indicates the thread and the dedicated monitoring task starts a diagnostic process and isolates a suspected circuit.

11. The method according to claim 6, wherein said critical section primitives are comprised of ‘Enter Critical Section’, ‘Leave Critical Section’, synchronize {}.

12. The method according to claim 6, wherein said decisional variables (S2, S3) are comprised of ‘owned’, ‘owner ID’, ‘Request Count’.

13. The method according to claim 6, wherein said executing the exclusive function code section if the status is granted further comprises setting one or more decisional variables to the thread (S9).

14. The method according to claim 6, wherein said suspending the thread if the status is not granted further comprises increasing a request count (S12).

15. A computer readable medium tangibly embodying a set of instructions readable and executable by a machine to perform method steps for minimizing the effect of synchronized I/O failures, the method steps comprising:
initializing critical section primitives for delimiting at least one critical section;
initializing decisional variables (S2, S3) for controlling and granting a thread access to the exclusive function code section;
determining a status of the exclusive function code section (S7) in response to a request for access (S5) to the exclusive function code section by the thread;
executing the exclusive function code section if the status is granted (S11), and, upon completion of execution, releasing the exclusive function code section (S23) and sending a release signal (S29);
suspending the thread if the status is not granted (S22), and upon receipt of a system time-out signal, executing the exclusive function code section and releasing the exclusive function code section upon completion of execution (S31), wherein
the at least one critical section contains no external dependency condition.

16. The computer readable medium as claimed in claim 15, wherein said method step of said critical section primitives are comprised of ‘Enter Critical Section’, ‘Leave Critical Section’, synchronize {}.

17. The computer readable medium as claimed in claim 15, wherein said decisional variables (S2, S3) are comprised of ‘owned’, ‘owner ID’, ‘Request Count’.

18. The computer readable medium as claimed in claim 15, wherein said method step of executing the exclusive function code section if the status is granted further comprises setting one of the decisional variables to the thread (S9).

19. The computer readable medium as claimed in claim 15, wherein said method step of suspending the thread if the status is not granted further comprises increasing a request count (S12).
